(19) United States
(12) Patent Application Publication
(10) Pub. No.: US 2025/0007204 A1
(43) Pub. Date: Jan. 2, 2025

(54) Connector Housing Assembly, Connector and Connector Assembly

(71) Applicant: Tyco Electronics (Shanghai) Co., Ltd., Shanghai (CN)

(72) Inventors: Yu Zhang, Shanghai (CN); Xiao (Nichee) Zhou, Shanghai (CN); Yuchen Yang, Shanghai (CN)

(73) Assignee: Tyco Electronics (Shanghai) Co., Ltd., Shanghai (CN)

(21) Appl. No.: 18/758,346

(22) Filed: Jun. 28, 2024

(30) Foreign Application Priority Data
Jun. 30, 2023 (CN) 202310799030.2

(51) Int. Cl. H01R 13/52; H01R 13/74

(52) U.S. Cl. CPC H01R 13/5202; H01R 13/74

(57) ABSTRACT

A connector housing assembly comprises a housing, a connecting member, and a sealing ring. The housing includes a flange portion formed with mounting holes. The connecting member passes through the mounting hole and is adapted to connect the flange portion to a mounting panel. The sealing ring is provided on the flange portion and is adapted to form a seal between the flange portion and the mounting panel. The connecting member is adapted such that, when the flange portion is connected to the mounting panel, the sealing ring is axially compressed between the flange portion and the mounting panel. The flange portion is movable axially and radially relative to the connecting member such that the housing is floatable axially and radially relative to the mounting panel.

### CROSS-REFERENCE TO RELATED APPLICATION

This application claims the benefit of Chinese Patent Application No. CN202310799030.2 filed on Jun. 30, 2023, in the State Intellectual Property Office of China, the whole disclosure of which is incorporated herein by reference.

### FIELD OF THE INVENTION

Embodiments of the present disclosure relate to a connector housing assembly, a connector comprising the connector housing assembly, and a connector assembly comprising the connector.

### BACKGROUND

In the prior art, a sealing structure of a connector may be located between a flange portion of a housing of the connector and a mounting panel. The flange portion of the housing is fixed to the mounting panel by bolts, compressing a sealing ring between the flange portion of the housing and the mounting panel, thereby forming a seal. This type of connector relies on a slight floating of the connector terminals to achieve mating even if an offset between the connector and a mating connector is present. However, as connector housing is fixed, when the offset between the two connectors that need to be mated is large, the two connectors cannot be mated.

### SUMMARY

According to an embodiment of the present disclosure, a connector housing assembly comprises a housing, a connecting member, and a sealing ring. The housing includes a flange portion formed with mounting holes. The connecting member passes through the mounting hole and is adapted to connect the flange portion to a mounting panel. The sealing ring is provided on the flange portion and is adapted to form a seal between the flange portion and the mounting panel. The connecting member is adapted such that, when the flange portion is connected to the mounting panel, the sealing ring is axially compressed between the flange portion and the mounting panel. The flange portion is movable axially and radially relative to the connecting member such that the housing is floatable axially and radially relative to the mounting panel.

### BRIEF DESCRIPTION OF THE DRAWINGS

The invention will now be described by way of example with reference to the accompanying Figures, of which:

FIG. 1 shows an illustrative perspective view of a connector assembly according to an exemplary embodiment of the present invention;

FIG. 2 shows an illustrative exploded view of a connector assembly according to an exemplary embodiment of the present invention;

FIG. 3 shows an illustrative perspective view of a connector housing assembly according to an exemplary embodiment of the present invention when viewed from the bottom;

FIG. 4 shows an illustrative exploded view of a connector housing assembly according to an exemplary embodiment of the present invention;

FIG. 5 shows a cross-sectional view of a connector assembly according to an exemplary embodiment of the present invention, wherein the connector is connected to a nut;

FIG. 6 shows a partially enlarged sectional view of the connector assembly shown in FIG. 5;

FIG. 7 shows a cross-sectional view of a connector assembly according to an exemplary embodiment of the present invention, wherein one connector has not yet been connected to a nut;

FIG. 8 shows a partially enlarged sectional view of the connector assembly shown in FIG. 7; and

FIG. 9 shows a cross-sectional view of a connector assembly according to an exemplary embodiment of the present invention, showing a sealing ring.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector housing assembly comprises a housing including a flange portion, connecting member, and a sealing ring. The flange portion is formed with mounting holes. The connecting member passes through the mounting holes and is used to connect the flange portion to a mounting panel. The sealing ring is provided on the flange portion to achieve sealing between the flange portion and the mounting panel. When the flange portion is connected to the mounting panel, the sealing ring is axially compressed between the flange portion and the mounting panel. The flange portion can be moved axially and radially relative to the connecting member, so that the housing can float axially and radially relative to the mounting panel.

According to another embodiment of the present disclosure, a connector includes the above connector housing assembly, and a terminal installed in the housing. In another embodiment, a connector assembly comprises the above connector, and a mounting panel on which the housing of the connector is floatable attached.

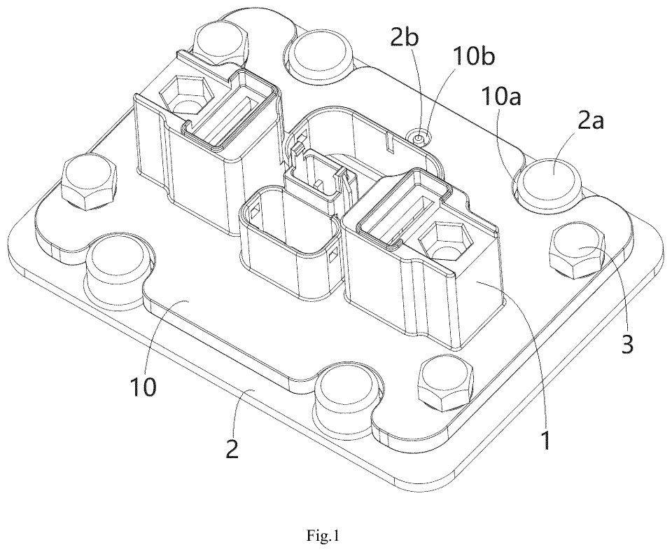

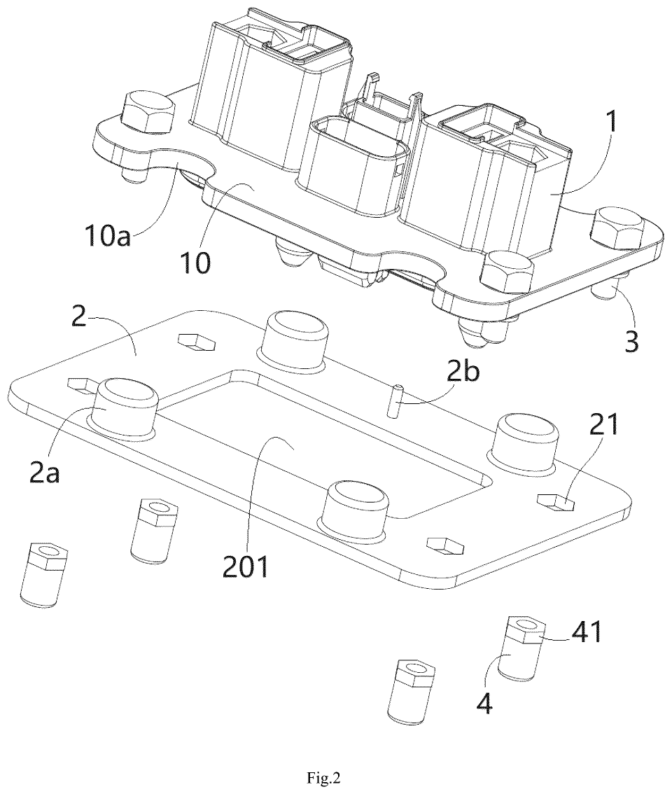

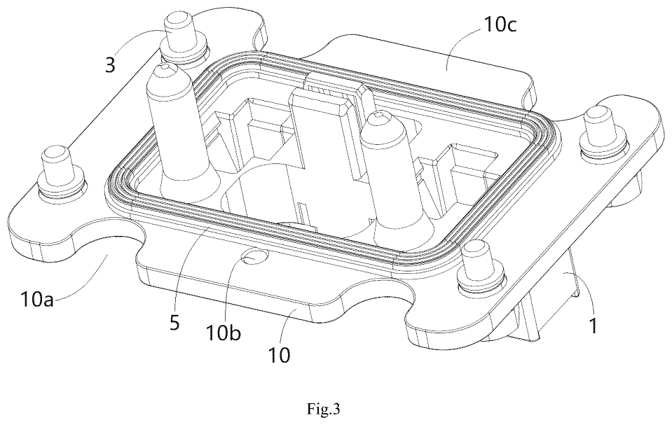

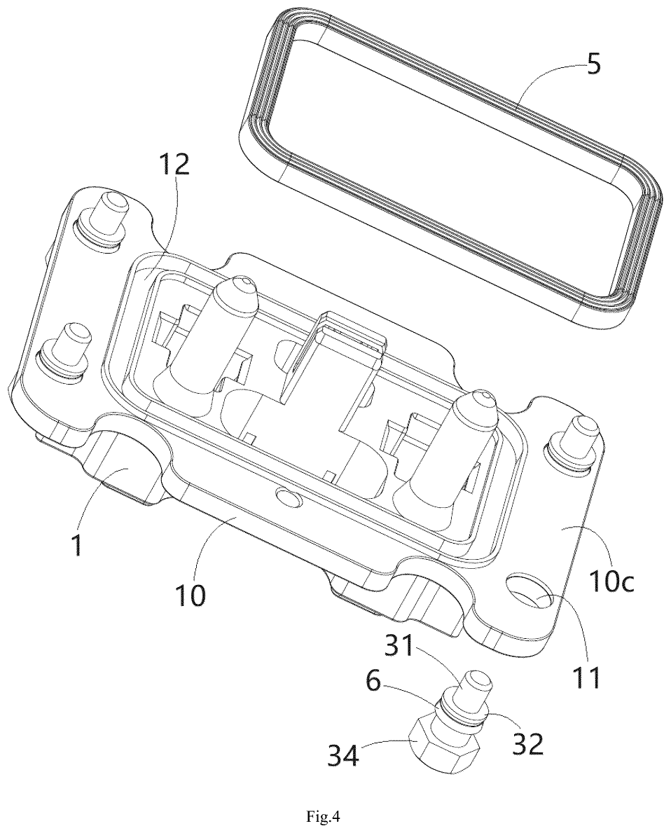

FIG. 1 shows an illustrative perspective view of a connector assembly according to an exemplary embodiment of the present disclosure. FIG. 2 shows an illustrative exploded view of a connector assembly according to an exemplary embodiment of the present disclosure. FIG. 3 shows an illustrative perspective view of a connector housing assembly according to an exemplary embodiment of the present disclosure when viewed from the bottom. FIG. 4 shows an illustrative exploded view of a connector housing assembly according to an exemplary embodiment of the present disclosure.

As shown in FIGS. 1-4, in an exemplary embodiment, a connector housing assembly is disclosed. The connector housing assembly mainly includes a housing 1, a connecting member 3, and a sealing ring 5. The housing 1 includes a flange portion 10 formed with mounting holes 11. The connecting member 3 passes through the mounting hole 11 of flange portion 10 to connect the flange portion 10 to the mounting panel 2. The sealing ring 5 is set on the flange portion 10 to achieve sealing between the flange portion 10 and the mounting panel 2.

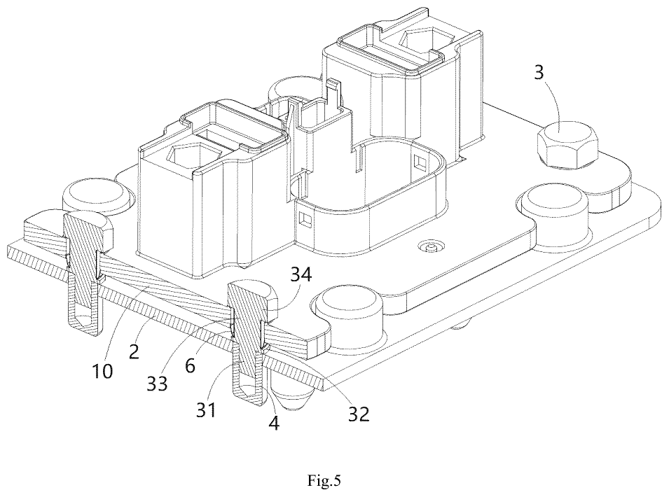

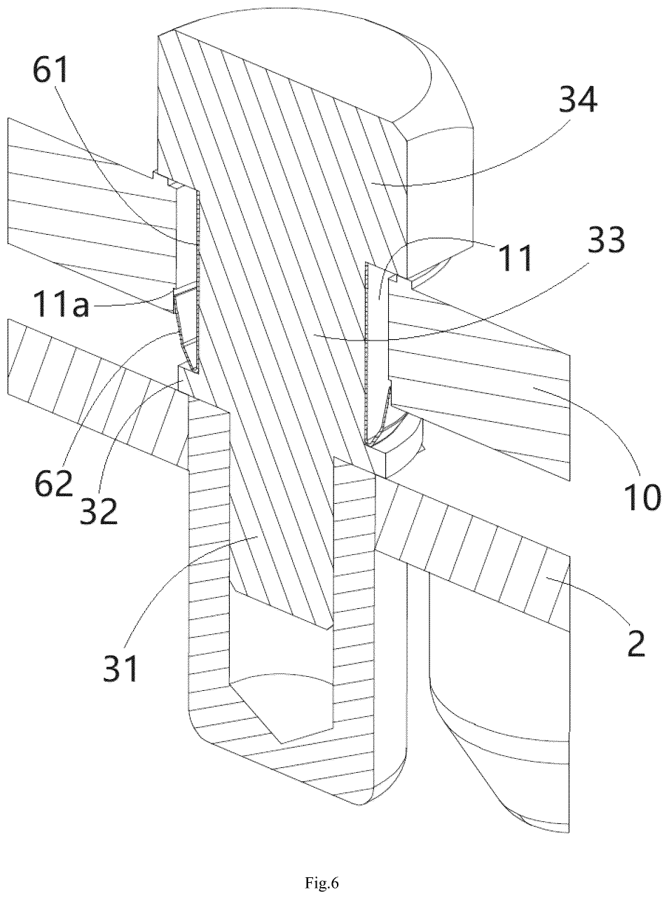

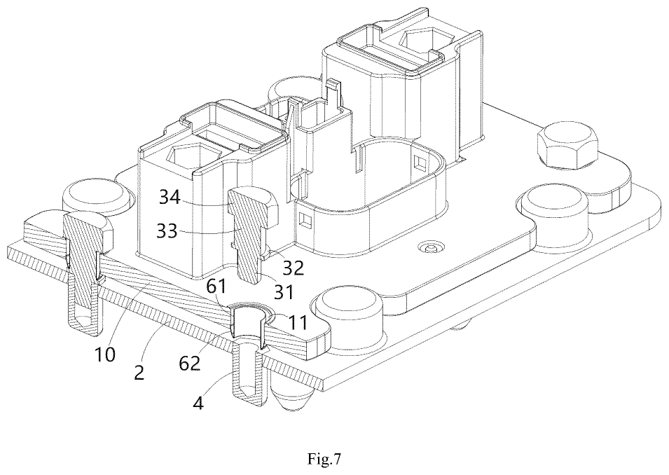

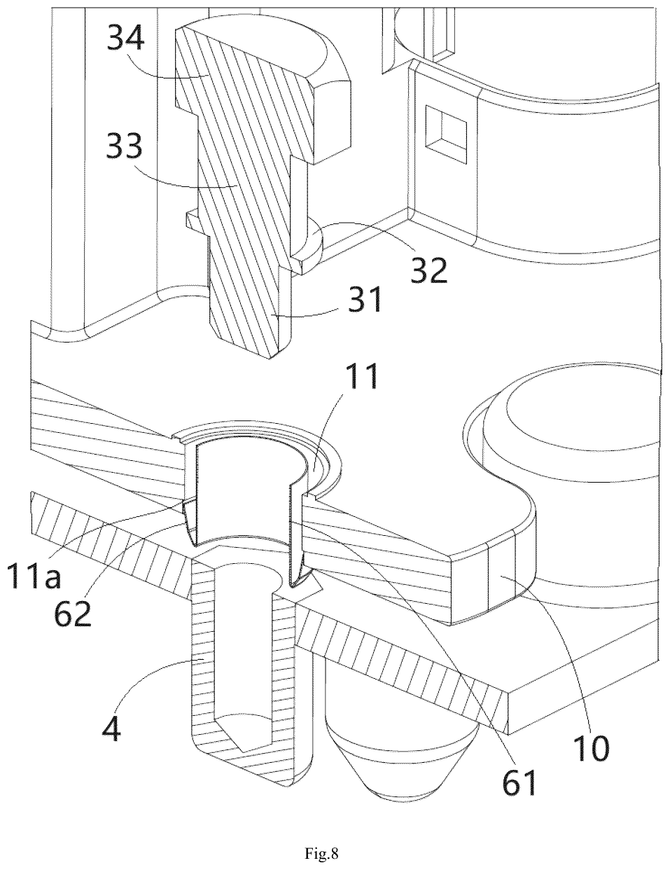

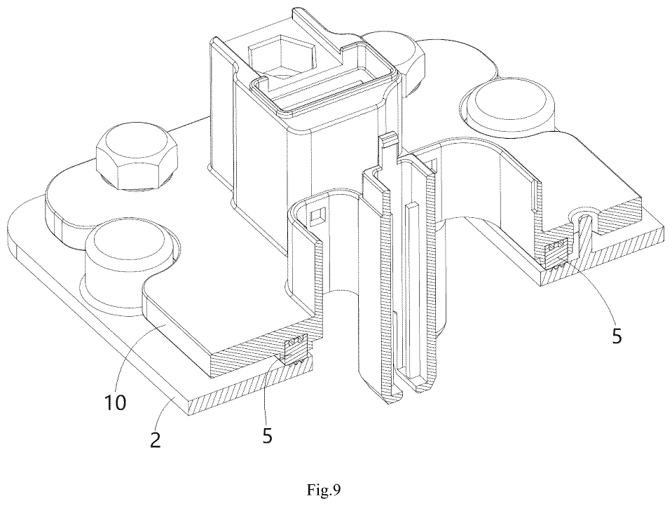

FIG. 5 shows a cross-sectional view of a connector assembly according to an exemplary embodiment of the present disclosure, wherein connecting member 3 is connected to nut 4. FIG. 6 shows a partially enlarged sectional view of the connector assembly shown in FIG. 5. FIG. 7 shows a cross-sectional view of a connector assembly according to an exemplary embodiment of the present disclosure, wherein one connecting member 3 is not yet connected to a nut 4. FIG. 8 shows a partially enlarged sectional view of the connector assembly shown in FIG. 7. FIG. 9 shows a cross-sectional view of a connector assembly according to an exemplary embodiment of the present disclosure, wherein the sealing ring 5 is shown.

As shown in FIGS. 1-9, in the illustrated embodiments, when the flange portion 10 of the housing 1 is connected to the mounting panel 2 by the connecting member 3, the sealing ring 5 is axially compressed between the flange portion 10 and the mounting panel 2. The flange portion 10 can be moved axially and radially relative to the connecting member 3. In this way, the housing 1 can float axially and radially relative to the mounting panel 2.

The flange portion 10 has a bottom surface 10c facing the mounting panel 2. The sealing ring 5 protrudes from the bottom surface 10c of the flange portion 10 to a predetermined height to suspend the housing 1 on the mounting panel 2. When the flange portion 10 is connected to the mounting panel 2, there is a predetermined gap between the bottom surface 10c of the flange portion 10 and the top surface of the mounting panel 2 to allow the housing 1 to float axially relative to the mounting panel 2.

When the housing 1 floats axially relative to the mounting panel 2, the sealing ring 5 will undergo elastic deformation along the axial direction of the connecting member 3. When the housing 1 floats radially relative to mounting panel 2, the sealing ring 5 will slide along the radial direction of connecting member 3 on the top surface of mounting panel 2. This achieves radial floating of the housing 1.

In the illustrated embodiments, the connecting member 3 mainly comprises a connecting portion 31, an operating portion 34, and a shaft portion 33. The connecting portion 31 is located at one end of the connecting member 3 and is suitable for threaded connection with the nut 4. The operating portion 34 is located at the other end of the connecting member 3 and is used to operate the connecting member 3, for example, to rotate the connecting member 3 and thread it with the nut 4. The shaft portion 33 is located between the connecting portion 31 and the operating portion 34. The shaft portion 33 is located in the mounting hole 11 of the flange portion 10, and the diameter of the shaft portion 33 is smaller than the inner diameter of the mounting hole 11. Therefore, there is a radial gap between the shaft portion 33 and the mounting hole 11, allowing the flange portion 10 to move radially relative to the connecting member 3, thereby allowing the housing 1 to float radially relative to the mounting panel 2.

The connecting member 3 further includes a flange 32, which is formed on the outer peripheral surface of the shaft portion 33 and adjacent to the connecting portion 31. The flange 32 is adapted to be supported on the top surface of the mounting panel 2, in order to position the connecting member 3 on the mounting panel 2. The diameter of the flange 32 of the connecting member 3 is smaller than the inner diameter of the mounting hole 11 to allow the flange 32 to pass through the mounting hole 11. The diameter of the operating portion 34 of connecting member 3 is greater than the inner diameter of the mounting hole 11 to prevent the operating portion 34 from being passed through the mounting hole 11. The shaft portion 33 of the connecting member 3 extends from the bottom surface of the flange 32 to the bottom surface of the operating portion 34, and the axial length of the shaft portion 33 is greater than the thickness of the flange portion 10, allowing the flange portion 10 to move axially relative to the connecting member 3.

The connector housing assembly further comprises a spring member 6. The spring member 6 is located in the gap between the shaft portion 33 and the mounting hole 11 to locate the centerline of the mounting hole 11. In this way, the centerline of the mounting hole 11 coincides with the centerline of the connecting member 3. In the illustrated embodiment, when the connecting member 3 is connected to the nut 4, the connecting member 3 is fixed and does not move. At this time, the spring member 6 pushes the housing 1 to align the centerline of mounting hole 11 with the centerline of connecting member 3.

The spring member 6 comprises a cylindrical body 61 and an elastic portion 62. The cylindrical body 61 is mounted on the shaft portion 33, and its upper and lower ends are respectively pressed against the operating portion 34 and the flange 32. The elastic portion 62 is connected to the lower end of the cylindrical body 61 and abuts against the inner side of the mounting hole 11. In the illustrated embodiment, the elastic portion 62 of the spring member 6 is in an upward opening trumpet shape. However, the present invention is not limited to this, and the elastic portion 62 may also have other suitable shapes.

Still referring to FIGS. 1-9, multiple mounting holes 11 are formed in the flange portion 10, for example, one mounting hole 11 is formed at each of the four corner parts of the flange portion 10. The connector housing assembly includes multiple connecting members 3 and multiple spring members 6 respectively arranged in multiple mounting holes 11. A step 11a is formed on the inner side of the mounting hole 11. The upper end of the elastic portion 62 of spring member 6 is against the support surface of step 11a to ensure that the flange portion 10 is in a horizontal orientation perpendicular to the axial direction of connecting component 3. This can prevent the housing 1 of the connector from becoming skewed during mating with the mating connector.

A sealing ring installation groove 12 is formed on the bottom surface of the flange portion 10. The sealing ring 5 is installed in the sealing ring installation groove 12. The sealing ring 5 protrudes from the bottom surface 10c of the flange portion 10 by a predetermined height.

In another exemplary embodiment of the present disclosure, as shown in FIGS. 1-9, a connector is also disclosed. The connector mainly includes the aforementioned connector housing assembly and a terminal installed in housing 1.

In another exemplary embodiment, a connector assembly is also disclosed. The connector assembly mainly includes the aforementioned connector and a mounting panel 2. As set forth above, the housing 1 of the connector is floatable installed on the mounting panel 2. The connector assembly further comprises a nut 4, which is threaded to the connecting member 3 of the connector for fastening the connecting member 3 to the mounting panel 2. A fitting hole 21 is formed in the mounting panel 2. One end 41 of the nut 4 is installed into the fitting hole 21. The cross section of the fitting hole 21 of mounting panel 2 and one end 41 of nut 4 forms a regular polygon to prevent the nut 4 from being rotated relative to the mounting panel 2.

Multiple positioning recesses 10a are formed on the edge of the flange portion 10 of the housing 1. Multiple positioning protrusions 2a are formed on the mounting panel 2, which are matched with multiple positioning recesses 10a to position the housing 1. An insertion hole 10b is formed in the flange portion 10 of the housing 1, and a pin 2b is formed on the mounting panel 2. The pin 2b is used to mate with the insertion hole 10b to ensure that housing 1 is installed in the correct orientation on the mounting panel 2. In the illustrated embodiment, when housing 1 is installed in the wrong orientation, the insertion hole 10b on the housing 1 will not align with the pin 2b on the mounting panel 2, resulting in the housing 1 being unable to be installed on mounting panel 2.

An opening 201 is formed on the mounting panel 2 for communication with the inner cavity of the housing 1, and the sealing ring 5 of the connector surrounds the opening 201. As shown in FIG. 9, in the illustrated embodiment, the sealing ring 5 suspends the flange portion 10 on the mounting panel 2, allowing the flange portion 10 to float axially. In this way, the gap between the flange portion 10 and the mounting panel 2 can be changed by axially compressing the sealing ring 5.

As shown in FIGS. 6 and 8, in the illustrated embodiments, the diameter of the mounting hole 11 of the flange portion 10 is greater than the diameter of the shaft portion 33 of the connecting member 3, resulting in a radial gap between the shaft portion 33 of the connecting member 3 and the mounting hole 11 of the flange portion 10, allowing the flange portion 10 to move radially.

Still referring to FIGS. 6 and 8, a spring member 6 is provided in the gap between the shaft portion 33 and the mounting hole 11. The elastic portion 62 of the spring member 6 is used to support the flange portion 10 radially, allowing the flange portion 10 to float radially.

Finally, in embodiments, the above-described connector assembly further includes a mating connector. A portion of the mating connector is inserted into the housing 1 of the connector through the opening 201 on the mounting panel 2 to mate with the connector.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector housing assembly, comprising:
a housing including a flange portion formed with mounting holes;
a connecting member passing through the mounting hole and adapted to connect the flange portion to a mounting panel; and
a sealing ring provided on the flange portion and adapted to form a seal between the flange portion and the mounting panel, the connecting member adapted such that, when the flange portion is connected to the mounting panel, the sealing ring is axially compressed between the flange portion and the mounting panel, and the flange portion is movable axially and radially relative to the connecting member such that the housing is floatable axially and radially relative to the mounting panel.

2. The connector housing assembly according to claim 1, wherein the flange portion has a bottom surface facing the mounting panel, the sealing ring protrudes from the bottom surface of the flange portion to a predetermined height to floatably support the housing on the mounting panel.

3. The connector housing assembly according to claim 1, wherein when the flange portion is connected to the mounting panel, a predetermined gap is formed between the bottom surface of the flange portion and the top surface of the mounting panel to allow the housing to float axially relative to the mounting panel.

4. The connector housing assembly according to claim 1, wherein the connecting member comprises:
a connecting portion arranged at one end of the connecting member and adapted to threadably engage with a nut;
an operating portion arranged at another end of the connecting member; and
a shaft portion arranged between the connecting portion and the operating portion, the shaft portion is provided in the mounting hole, and a diameter of the shaft portion is smaller than an inner diameter of the mounting hole such that the flange portion can move radially relative to the connecting member.

5. The connector housing assembly according to claim 4, wherein the connecting member further comprises a flange arranged on the outer peripheral surface of the shaft portion and adjacent to the connecting portion, the flange is adapted to be supported on the top surface of the mounting panel to position the connecting member on the mounting panel.

6. The connector housing assembly according to claim 5, wherein:
a diameter of the flange is smaller than the inner diameter of the mounting hole to allow the flange to pass through the mounting hole; and
a diameter of the operating portion is greater than the inner diameter of the mounting hole to prevent the operating portion from passing through the mounting hole.

7. The connector housing assembly according to claim 5, wherein the shaft portion extends from a bottom surface of the flange to a bottom surface of the operating portion, and an axial length of the shaft portion is greater than a thickness of the flange portion, allowing the flange portion to move axially relative to the connecting member.

8. The connector housing assembly according to claim 5, further comprising a spring member arranged in a gap between the shaft portion and the mounting hole and locating a centerline of the mounting hole to coincide with a centerline of the connecting member.

9. The connector housing assembly according to claim 8, wherein the spring member comprises:
a cylindrical body fitted on the shaft portion and having upper and lower ends arranged respectively against the operating portion and the flange; and
an elastic portion connected to the lower end of the cylindrical body and abutting against an inner side of the mounting hole.

10. The connector housing assembly according to claim 9, wherein the elastic portion of the spring member has an upward opening trumpet shape.

11. The connector housing assembly according to claim 9, wherein:
multiple mounting holes are formed in the flange portion, and the connector housing assembly comprises multiple connecting members and multiple spring members respectively arranged in the multiple mounting holes; and
a step is formed on the inner side of the mounting hole, and the upper end of the elastic portion is against the support surface of the step to ensure that the flange portion is in a horizontal orientation perpendicular to the axial direction of the connecting member.

12. The connector housing assembly according to claim 1, wherein a sealing ring installation groove is formed on the bottom surface of the flange portion, and the sealing ring is installed in the sealing ring installation groove.

13. The connector housing assembly according to claim 1, wherein the housing of the connector housing assembly comprises a terminal opening adapted to receive a terminal.

14. A connector assembly, comprising:
a connector housing assembly, including:
a housing including a flange portion formed with mounting holes;
a connecting member passing through the mounting hole and adapted to connect the flange portion to a mounting panel; and
a sealing ring provided on the flange portion and adapted to form a seal between the flange portion and the mounting panel, the connecting member adapted such that, when the flange portion is connected to the mounting panel, the sealing ring is axially compressed between the flange portion and the mounting panel, and the flange portion is movable axially and radially relative to the connecting member such that the housing is floatable axially and radially relative to the mounting panel; and
a mounting panel on which the housing of the connector housing assembly is floatable installed.

15. The connector assembly according to claim 14, further comprising a nut threaded onto the connecting member of the connector and fastening the connector to the mounting panel.

16. The connector assembly according to claim 15, wherein:
a fitting hole is formed in the mounting panel, and one end of the nut is installed into the fitting hole; and
a cross-sectional area of the fitting hole and one end of the nut forms a regular polygon to prevent the nut from being rotated relative to the mounting panel.

17. The connector assembly according to claim 14, wherein multiple positioning recesses are formed on an edge of the flange portion of the housing, and multiple positioning protrusions are formed on the mounting panel, which are respectively matched with the multiple positioning recesses to position the housing.

18. The connector assembly according to claim 14, wherein an insertion hole is formed in the flange portion of the housing, and a pin is formed on the mounting panel, the pin cooperating with the insertion hole to ensure that the housing is installed in a correct orientation on the mounting panel.

19. The connector assembly according to claim 14, wherein an opening is formed on the mounting panel and is in communication with the inner cavity of the housing, and the sealing ring of the connector surrounds the opening.

20. The connector assembly according to claim 19, wherein the housing of the connector housing assembly is adapted to receive a portion of a mating connector though the opening on the mounting panel.
